(19) United States
(12) Patent Application Publication
(10) Pub. No.: US 2026/0056092 A1
(43) Pub. Date: Feb. 26, 2026

(54) SAMPLING SYSTEM AND SAMPLING METHOD

(71) Applicants: SHANGHAI MORIMATSU PHARMACEUTICAL EQUIPMENT ENGINEERING CO., LTD., Shanghai (CN); Zencore Biologics Co., Ltd., Shanghai (CN)

(72) Inventors: Sheng HUANG, Shanghai (CN); Pei JIANG, Shanghai (CN); Xueming CHEN, Shanghai (CN); Kang CHENG, Shanghai (CN); Yang ZHAO, Shanghai (CN); Yimu SUN, Shanghai (CN); Yu CHEN, Shanghai (CN)

(73) Assignees: SHANGHAI MORIMATSU PHARMACEUTICAL EQUIPMENT ENGINEERING CO., LTD., Shanghai (CN); Zencore Biologics Co., Ltd., Shanghai (CN)

(21) Appl. No.: 19/378,264

(22) Filed: Nov. 3, 2025

(30) Foreign Application Priority Data
Jun. 19, 2025 (CN) 202510831052.1

(51) Int. Cl. G01N 1/14; B25J 15/00; G01N 35/00

(52) U.S. Cl. CPC G01N 1/14; B25J 15/0033; G01N 35/0099; G01N 2001/1427

(57) ABSTRACT

The embodiments of the present application provide a sampling system and a sampling method, which relate to the field of sampling technologies. The sampling system includes: a tube assembly; a liquid container and at least one sampling container, where the sampling container is in communication with the liquid container through the tube assembly, and the tube assembly automatically controls the liquid in the liquid container to enter or stop entering the sampling container; and a processing device, configured to separate the sampling container from the tube assembly and transfer the sampling container. The sampling system and sampling method provided in the embodiments of the present application solve the problems in the prior art that contamination is easily caused to the clean workshop or the liquid during sampling, and the sampling risks are easily caused by inconsistent sampling operations of the operator.

### CROSS-REFERENCE TO RELATED APPLICATION

This application claims the priority benefit of China application serial no. 202510831052.1, filed on Jun. 19, 2025, which is hereby incorporated by reference in its entirety.

### BACKGROUND

### Technical Field

The present application relates to the field of sampling technologies, and in particular, to a sampling system and a sampling method.

### Description of Related Art

During the production process of some products, the use of clean workshops is an important element in ensuring product cleanliness and sterility.

In the related art, when it is necessary to perform sampling on a liquid container in the clean workshop, the operator usually changes into clean clothes and then enters the clean workshop to manually take out a sample of the liquid, and then sends the sample out of the clean workshop.

However, the above-mentioned sampling method is prone to contamination of the clean workshop or the liquid. And there's some risk of not proper sample be taken due to not completely follow specific sampling standard operation procedures.

### SUMMARY

The embodiments of the present application provide a sampling system and a sampling method, so as to solve the problems in the prior art that contamination is easily caused to the clean workshop or the liquid during sampling, and the sampling risks are easily caused by inconsistent sampling operations of the operator.

According to a first aspect, an embodiment of the present application provides a sampling system, including:
a tube assembly;
a liquid container and at least one sampling container;
where the sampling container is in communication with the liquid container through the tube assembly, and the tube assembly automatically controls liquid in the liquid container to enter or stop entering the sampling container; and
a processing device, configured to separate the sampling container from the tube assembly and transfer the sampling container.

In a possible embodiment, there are a plurality of sampling containers, the plurality of sampling containers form at least one group of sampling assemblies, and respective sampling containers in the same group of sampling assemblies are connected to each other.

In a possible embodiment, the sampling system further includes at least one common joint and at least one branch tube, where the sampling containers in the same group are correspondingly in communication with the common joint through the branch tube, and the common joint is in communication with the tube assembly.

In a possible embodiment, at least one sampling valve is provided on the common joint, each sampling valve is correspondingly provided on each branch tube, and the processing device is further configured to control actions of the sampling valve, so as to control opening and closing of the branch tube.

In a possible embodiment, at least part of the branch tube is a to-be-cut portion, and the to-be-cut portion is configured to be bent by the processing device after being cut by the processing device, so as to complete sealing.

In a possible embodiment, the sampling system further includes a cabinet body, and each sampling container is provided on the cabinet body.

In a possible embodiment, the sampling system further includes at least one fixing clamp, and the fixing clamp is configured to fix the sampling container on the cabinet body.

In a possible embodiment, the tube assembly includes a main tube, an automatic valve provided in the main tube, and a detecting sensor; where the sampling container is in communication with the liquid container through the main tube;
the automatic valve is configured to control opening and closing of the main tube; and
the detecting sensor is configured to detect a flow rate of a liquid flow through the main tube.

In a possible embodiment, the processing device includes a movable robot, and the moving robot has a gripper and a cutting device, where the gripper is configured to clamp the sampling container and the cutting device is configured to detach the sampling container from the tube assembly.

According to a second aspect, an embodiment of the present application provides a sampling method, which is applied to the sampling system in any one of the above-mentioned embodiments, and includes the following steps:
transferring part of the liquid in the liquid container to the sampling container in the sampling system through the tube assembly in the sampling system;
separating the sampling container containing the liquid from the tube assembly through the processing device in the sampling system; and
transferring the sampling container containing the liquid to a designated area through the processing device.

The embodiments of the present application provide a sampling system and a sampling method, where the sampling system includes: a tube assembly; a liquid container and at least one sampling container, where the sampling container is in communication with the liquid container through the tube assembly, and the tube assembly automatically controls the liquid in the liquid container to enter or stop entering the sampling container; and a processing device, configured to separate the sampling container from the tube assembly and transfer the sampling container. Therefore, a designated area can be set in advance in the clean workshop for fetching and placing the sampling container. During operation, part of the liquid in the liquid container is controlled to automatically enter the sampling container through the tube assembly, so as to complete sampling. The sampling container containing the liquid is then separated from the tube assembly by the processing device and transferred to the designated area. Subsequently, the operator only needs to fetch the sampling container from the designated area, so that the operator does not need to enter the clean workshop for manual sampling, thereby reducing the possibility of contamination to the clean workshop and the sampled liquid, and improving the sampling efficiency at the same time. In addition, during the whole process of sampling, the manual operations load are reduced, so that the data compliance problem arising from the manual operations can be effectively reduced, and the risk of sampling can be reduced at the same time, thereby solving the problems in the prior art that the contamination is easily caused to the clean workshop or the liquid during sampling, and the sampling risks are easily caused by inconsistent sampling operations of the operator.

### BRIEF DESCRIPTION OF THE DRAWINGS

The accompanying drawings, which are incorporated herein and form part of the description, illustrate embodiments consistent with the present application and are used together with the description to explain the principles of the present application.

FIG. 1 is a schematic diagram of a mounting structure of a sampling system according to the present application.

FIG. 2 is a schematic structural diagram of a sampling device in a sampling system according to the present application.

FIG. 3 is a schematic structural diagram of a processing device in a sampling system according to the present application.

FIG. 4 is an enlarged schematic structural diagram of portion A in FIG. 2.

FIG. 5 is a partial schematic structural diagram of a common joint in FIG. 2.

Through the above accompanying drawings, the specific embodiments of the present application have been illustrated, and more detailed descriptions will be provided in the following description. These accompanying drawings and description are not intended to limit the scope of the present application in any way, but rather to illustrate the concept of the present application for those skilled in the art by referring to the specific embodiments.

### DESCRIPTION OF THE EMBODIMENTS

The exemplary embodiments will be described in detail herein, with the examples thereof shown in the accompanying drawings. When the following description refers to the accompanying drawings, unless otherwise indicated, the same numbers in different drawings represent the same or similar elements. The embodiments described in the following exemplary embodiments do not represent all embodiments consistent with the present application. On the contrary, they are merely examples of apparatus and methods consistent with some aspects of the present application as detailed in the appended claims.

In the related art, when it is necessary to perform sampling on a liquid container in the clean workshop, the operator usually changes into clean clothes and then enters the clean workshop to manually take out a sample of the liquid, and then sends the sample out of the clean workshop.

However, when multiple batches are required to enter the clean workshop for sampling, the operator needs to frequently enter and exit the clean workshop, which can easily cause contamination to the clean workshop or the liquid, and the sampling efficiency is relatively low. Moreover, if the operator fails to operate according to specific standard operation procedure, there may be a risk of not proper samples be taken and also data compliance problem.

Thus, the embodiments of the present application provide a sampling system and a sampling method, where the sampling system includes: a tube assembly; a liquid container and at least one sampling container, where the sampling container is in communication with the liquid container through the tube assembly, and the tube assembly automatically controls the liquid in the liquid container to enter or stop entering the sampling container; and a processing device, configured to separate the sampling container from the tube assembly and transfer the sampling container. Thus, a designated area can be set in advance in the clean workshop, so as to fetch and place the sampling container. During operation, part of the liquid in the liquid container is controlled to automatically enter the sampling container through the tube assembly, so as to complete sampling. The sampling container containing the liquid is then separated from the tube assembly by the processing device and transferred to the designated area. Subsequently, the operator only needs to fetch the sampling container from the designated area, so that the operator does not need to enter the clean workshop for manual sampling, thereby reducing the possibility of contamination to the clean workshop and the liquid, and improving sampling efficiency at the same time. In addition, during the whole process of sampling, the manual operations are reduced, so that the possibility of the data compliance problem arising from the manual operations can be effectively reduced, and the risk of sampling can be reduced at the same time, thereby solving the problems in the prior art that the contamination is easily caused to the clean workshop or the liquid during sampling, and the sampling risks are easily caused by inconsistent sampling operations of the operator.

The technical solution of the present application and how the technical solution of the present application solves the above technical problems will be described in detail below with reference to specific embodiments. The following several specific embodiments may be combined with each other, and the same or similar concepts or procedures may not be repeated in certain embodiments. The embodiments of the present application will be described below with reference to the accompanying drawings.

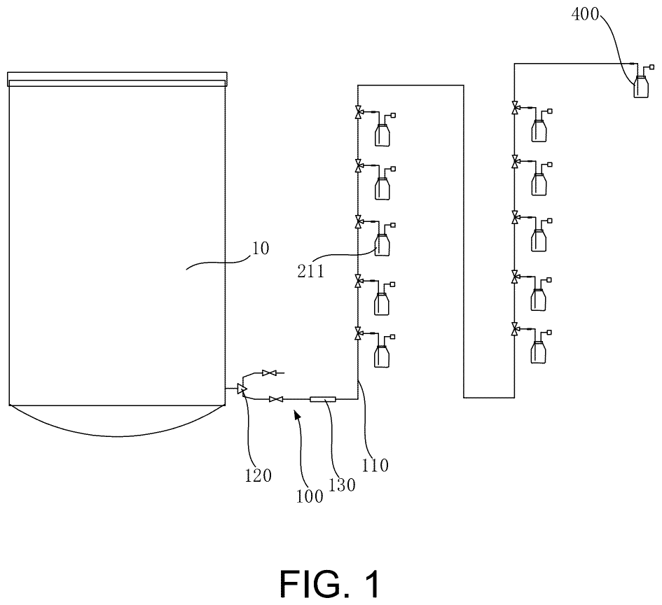

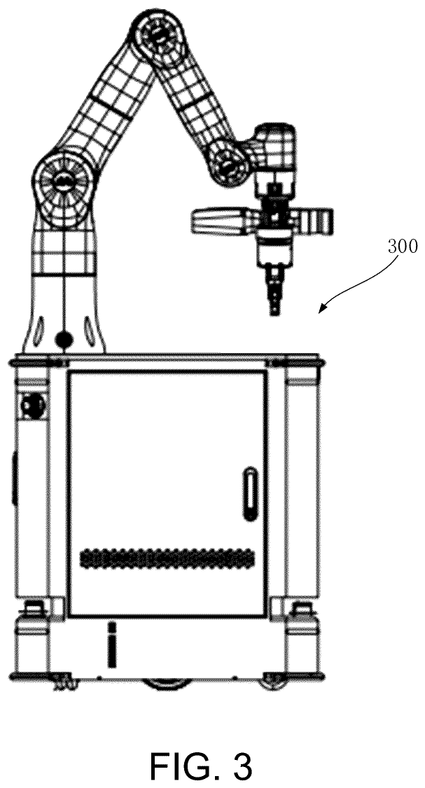

As shown in FIGS. 1, 2 and 3, an embodiment of the present application provides a sampling system, including:
a tube assembly 100;
a liquid container 10 and at least one sampling container 211;
where the sampling container 211 is in communication with the liquid container 10 through the tube assembly 100, and the tube assembly 100 automatically controls liquid in the liquid container 10 to enter or stop entering the sampling container 211; and
a processing device 300, configured to separate the sampling container 211 from the tube assembly 100, and transfer the sampling container 211.

The liquid container 10 may be a storage tank or a storage box for holding the liquid on site, and the model and shape thereof are not limited herein.

It should be noted that the sampling system may include a sampling device 200 that includes at least one group of sampling assemblies 210. In this case, there are a plurality of sampling containers 211, the plurality of sampling containers 211 form at least one group of sampling assemblies 210, and respective sampling containers 211 in the same group of sampling assemblies 210 are connected to each other. During implementation, five sampling containers 211 can be set as a group of sampling assemblies 210 according to practical requirements, but other quantities may be also possible, which is not limited herein.

The sampling container 211 may be a sampling bag, a sampling bottle, or other containers, and the sampling container 211 can package part of the liquid, which is not limited herein.

The processing device 300 includes a moving robot, and the moving robot has a gripper and a cutting device, where the gripper is configured to clamp the sampling container 211 and the cutting device is configured to detach the sampling container 211 from the tube assembly 100. Furthermore, one moving robot can serve a plurality of sampling Dockers.

Specifically, the moving robot communicates through WiFi or 5G, which is not limited herein; and is provided with a vision system to control the movement of the moving robot and the actions of the gripper and the cutting device. The gripper may be a clamping jaw or a tray, and the cutting device may be a scissor or a cutting knife. The specific model of the moving robot may be reasonably selected according to existing products, which is not limited herein.

During implementation, a designated area may be set in advance in the clean workshop, at the window or at the entrance and exit, for placing the sampling container 211. During operation, part of the liquid in the liquid container 10 is controlled by the tube assembly 100 to automatically enter the sampling container 211, so as to complete sampling.

Subsequently, the sampling container 211 is clamped by the gripper of the processing device 300, the sampling container 211 containing the liquid is separated from the tube assembly 100 through the cutting device, and finally the sampling container 211 is transferred to the designated area through the moving robot. Then, the operator only needs to remove the sampling container 211 from the designated area, so that the operator does not need to enter the clean workshop for manual sampling, thereby reducing the possibility of contamination to the clean workshop and the liquid, and improving the sampling efficiency at the same time. In addition, during the whole process of sampling, the manual operations are reduced, so that the data compliance problem occurring due to the manual operations can be effectively reduced, and the risk of sampling can be reduced at the same time, thereby solving the problems in the prior art that the contamination is easily caused to the clean workshop or the liquid during sampling, and the sampling risks are easily caused by inconsistent sampling operations of the operator.

As shown in FIG. 1, in some embodiments, the tube assembly 100 includes a main tube 110, an automatic valve 120 provided in the main tube 110, and a detecting sensor 130; where
the sampling container 211 is in communication with the liquid feed container 10 through the main tube 110;
the automatic valve 120 is configured to control opening and closing of the main tube 110; and
the detecting sensor 130 is configured to detect a flow rate of the liquid in the main tube 110.

Specifically, one end of the main tube 110 is in communication with the liquid container 10, and the other end thereof is in communication with each sampling container 211 in each sampling assembly 210. During implementation, the main tube 110 may be connected to a tube of the liquid container 10 through a sterile connecting machine, so that the main tube 110 is in communication with the liquid container 10. The automatic valve 120 and the detecting sensor 130 are both mounted in the main tube 110. The automatic valve 120 and the detecting sensor 130 can be provided at one end of the main tube 110 close to the liquid feed container 10, and can also be provided at the middle section of the main tube 110, as long as the automatic valve 120 and the detecting sensor 130 are located at the front end of the sampling container 211, and the specific mounting positions are not limited herein. The opening and closing of the main tube 110 can be controlled by the automatic valve 120, so as to control whether the liquid in the liquid container 10 flows towards one end of the sampling container 211. The flow rate of the liquid in the main tube 110 is detected by the detecting sensor 130, so that the automatic valve 120 can be closed in a timely manner to control the outflow volume of the liquid, thereby ensuring the sampling process to be safe and reducing waste.

The automatic valve 120 may be selected from existing products according to requirements, such as a pneumatic ball valve, a pneumatic butterfly valve or other valves, and may also control the action of the automatic valve 120 through PLC (Programmable Logic Controller), which is not limited herein. The detecting sensor 130 may be a flow meter, and the flow meter may be reasonably selected from existing products according to requirements.

During implementation, a diaphragm valve, a pump, a pressure gauge, a waste liquid tube, or other components may also be added to the main tube 110 according to actual requirements. The waste liquid tube is provided at one end of the main tube 110 away from the liquid container 10, then a valve configured to control whether the waste liquid flows out can be disposed on the waste liquid tube, and a waste liquid container 400 configured to collect the waste liquid can be provided at an outlet of the waste liquid tube, so as to process the waste liquid.

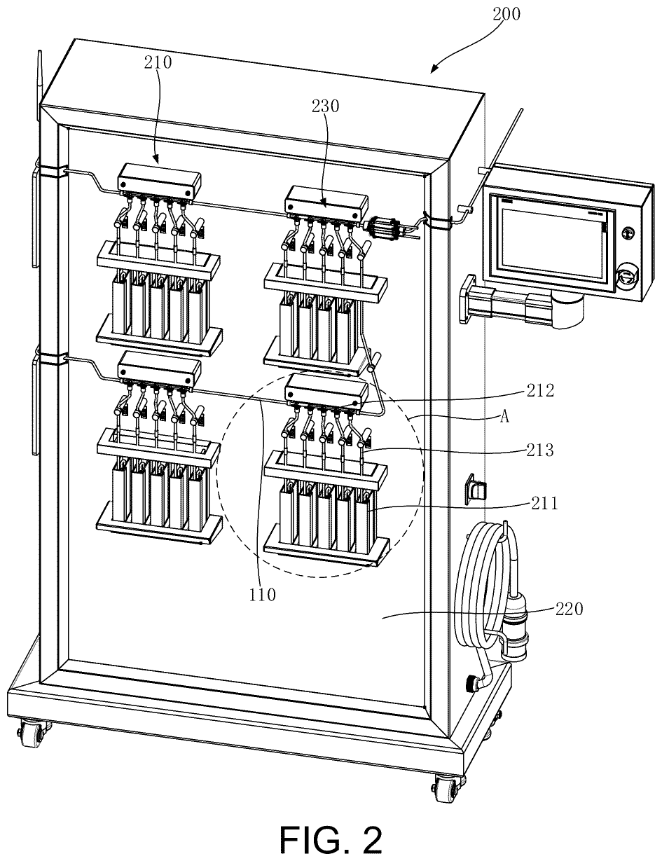

As shown in FIG. 2, in some embodiments, the sampling system further includes a cabinet body 220, and each group of the sampling containers 211 is provided on the cabinet body 220.

In this embodiment, the sampling device 200 further includes the cabinet body 220, and each group of the sampling containers 211 is provided on the cabinet body 220, and a plurality of casters are provided at a bottom of the cabinet body 220.

Thus, the entire sampling device 200 can be moved by moving the cabinet body 220, thereby facilitating the simultaneous movement of the plurality of sampling containers 211 to the vicinity of the liquid container 10 and improving the convenience of connecting each sampling container 211 to the liquid container 10. Furthermore, the casters can make the cabinet body 220 move more convenient when moving.

During implementation, the caster can be configured as a caster with a brake, so that after the cabinet body 220 moves, the caster wheel can be locked through the brake, thereby improving the stability of the cabinet body 220 and the sampling containers 211 during subsequent use.

During implementation, a control system can also be provided on the cabinet body 220, and the sampling device 200 establishes WiFi or 5G communication connection with the moving robot through the control system, which is not limited, thereby facilitating the control of the moving robot. The plurality of Dockers can form a network, which is scheduled by a central server, and one moving robot can serve the plurality of sampling Dockers.

As shown in FIG. 2, in some embodiments, the sampling system further includes at least one common joint 212 and at least one branch tube 213, where the sampling containers 211 in the same group are correspondingly in communication with the common joint 212 through the branch tube 213, and the common joint 212 is in communication with the tube assembly 100.

In this embodiment, the sampling assembly 210 further includes the common joint 212 and at least one branch tube 213 that are provided on the cabinet body 220, each sampling container 211 is correspondingly in communication with the common joint 212 through each branch tube 213, and the common joint 212 is in communication with the tube assembly 100.

In addition, at least one sampling valve 214 is provided on the common joint 212, each sampling valve 214 is correspondingly provided on each branch tube 213, and the processing device 300 is further configured to control the actions of the sampling valve 214, so as to control opening and closing of the branch tube 213.

It should be noted that an interior of the common joint 212 is hollow, and one end of each branch tube 213 is in communication with the common joint 212, while the other end of each branch tube 213 is correspondingly in communication with each sampling container 211.

In this case, one end of the main tube 110 in the tube assembly 100 away from the liquid container 10 is in communication with the common joint 212, so that the liquid in the liquid container 10 can be loaded into different sampling containers 211 through respective branch tubes 213 after passing through the common joint 212, thereby facilitating batch or multiple sampling of the liquid. The branch tube 213 may be a flexible tube or a rigid tube, which is not limited herein.

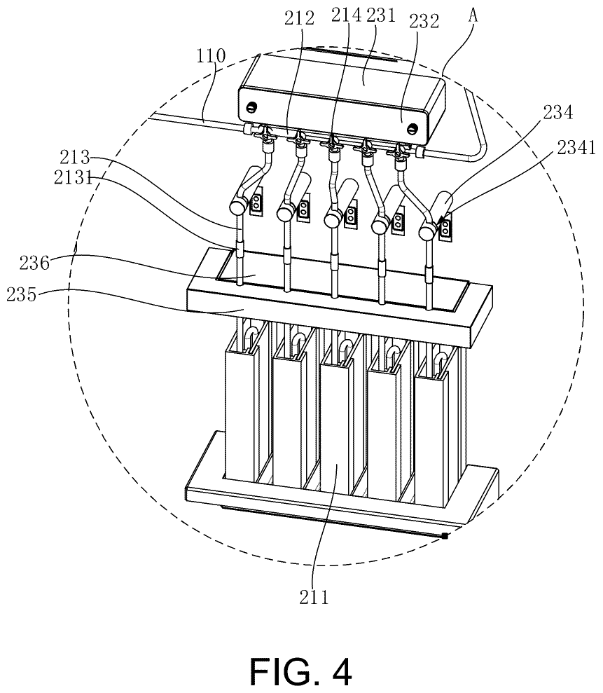

As shown in FIGS. 2 and 4, the sampling valves 214 are provided corresponding to the number of branch tubes 213. The sampling valves 214 are mounted on the common joint 212, and each sampling valve 214 is respectively provided corresponding to each branch tube 213, thereby controlling the opening and closing of the corresponding branch tube 213 by the sampling valve 214.

During operation, after the automatic valve 120 is opened, the sampling valve 214 can be controlled by the gripper of the moving robot, so that the liquid in the main tube 110 enters the sampling container 211 at the current position to complete the sampling. Next, the gripper of the moving robot clamps the sampling container 211 containing the liquid, and then the separation operation of the sampling container 211 is completed. For example, the branch tube 213 is cut off by the cutting device of the moving robot to complete the separation operation of the sampling container 211.

During implementation, different numbers of groups of sampling assemblies 210 can be provided on the cabinet body 220 according to practical requirements, and the common joints 212 in respective groups of sampling assemblies 210 can be in communication with each other. The sampling valve 214 may be a three-way valve or other type of valve, which is not limited herein.

Furthermore, the sampling system further includes at least one fixing clamp 230, and the fixing clamp 230 is configured to fix the sampling container 211 on the cabinet body 220.

As shown in FIG. 2, the fixing clamp 230 is provided on the cabinet body 220 corresponding to each group of sampling assemblies 210, and the fixing clamp 230 is configured to fix at least one of the common joint 212, the branch tube 213 and the sampling container 211 on the cabinet body 220.

The fixing clamp 230 may be a bolt, a screw, a positioning pin, a buckle, a clamping block, a clamping plate or other components, so that the fixing clamp 230 can fix at least one of the common joint 212, the branch tube 213 and the sampling container 211 to the cabinet body 220, which is not limited herein.

In this embodiment, there may be a plurality of fixing clamps 230, so that each fixing clamp 230 can respectively fix the common joint 212, the branch tube 213 and the sampling container 211 on the cabinet body 220, and the common joint 212, the branch tube 213 and the sampling container 211 are detachably connected with the cabinet body 220, thereby improving the mounting stability of the common joint 212, the branch tube 213 and the sampling container 211.

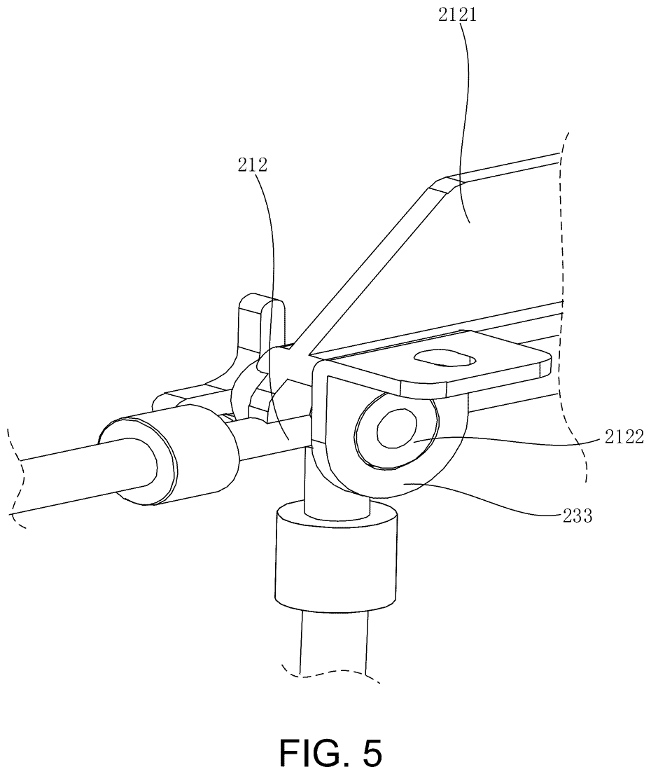

Regarding the fixing of the common joint 212, as shown in FIGS. 4 and 5, exemplarily, the common joint 212 is provided with a connecting plate 2121, and the fixing clamp 230 includes a base 231, a clamping plate 232 and a locking member. The base 231 can be screwed, welded or otherwise fixed on the cabinet body 220, an upper end of the clamping plate 232 is rotatably connected to the base 231, and the locking member is configured to lock the clamping plate 232 to the base 231 and clamp the connecting plate 2121 between the base 231 and the clamping plate 232. The locking member may be a screw, a bolt or a buckle.

The fixing clamp 230 further includes at least one positioning plate 233, the positioning plate 233 can be fixed on the cabinet body 220 or the base 231 by screwing, welding or other means, and the positioning plate 233 is provided with a positioning hole. The common joint 212 is provided with at least one positioning pin 2122, and the positioning pin 2122 is correspondingly inserted into the positioning hole, so as to position the common joint 212 on the cabinet body 220.

During installation, each positioning pin 2122 can be correspondingly inserted into the positioning hole of the positioning plate 233, thereby achieving the purpose of positioning the common joint 212. Then, the connecting plate 2121 is clamped between the base 231 and the clamping plate 232, so as to complete the installation of the common joint 212 on the cabinet body 220, thereby causing that the common joint 212 has better stability after it is installed, and the installation process is relatively convenient.

Regarding the fixing of the branch tube 213, as shown in FIG. 4, exemplarily, the fixing clamp 230 may further include a positioning post 234, which can be fixed on the cabinet body 220 by screwing, welding or other means. The positioning post 234 has a positioning slot 2341, and the branch tube 213 is clamped in the positioning slot 2341. Thus, the branch tubes 213 can be supported and positioned on the cabinet body 220, and the stability during use can be ensured.

As shown in FIG. 4, the fixing clamp 230 may further include a positioning block 235, a moving block 236, and a driving member, where the positioning block 235 and the moving block 236 are located at two sides of the branch tube 213 respectively, and the moving block 236 is located at a side of the positioning block 235 facing the cabinet body 220. The positioning block 235 can be fixed on the cabinet body 220 by screwing, welding or other means, an accommodating groove is correspondingly provided at one end of the positioning block 235 facing the branch tube 213, and the branch tube 213 is accommodated in the accommodating groove. The driving member can be fixed on the cabinet body 220 by screwing, welding or other means, the driving member can be an air cylinder or a hydraulic cylinder, and a movable end of the driving member is connected to the moving block 236, so that the driving member can drive the moving block 236 to move and abut against the positioning block 235, thereby restricting the branch tube 213 in the accommodating groove, and further improving the stability of the branch tube 213.

As shown in FIG. 4, in some embodiments, at least part of the branch tube 213 is a to-be-cut portion 2131, and the to-be-cut portion 2131 is configured to be bent by the processing device 300 after being cut by the processing device 300, so as to complete sealing.

The to-be-cut portion 2131 is made of stainless steel material, so that after the to-be-cut portion 2131 is cut off, the edge of the tube orifice at the to-be-cut portion 2131 is bent by the processing device 300 to achieve sealing.

Thus, after the sampling container 211 has collected the liquid, the branch tube 213 can be cut at the to-be-cut portion 2131 by the cutting device of the processing device 300, thereby separating the sampling container 211. Furthermore, after the to-be-cut portion 2131 is cut off, the edge of the tube orifice at the to-be-cut portion 2131 is bent to achieve sealing, thereby reducing the possibility of the liquid leakage during the subsequent process of transferring the sampling container 211.

During implementation, a carrying plate may be added to the cabinet body 220, so that the sampling container 211 can be placed on the carrying plate, thereby reducing the possibility of dropping the sampling container 211. In this case, the fixing clamp 230 only needs to fix at least one of the common joint 212 and the branch tube 213 to the cabinet body 220. Based on this, the processing device 300 may directly cut off the to-be-cut portion 2131 through the cutting device, and bend the edge of the tube orifice at the to-be-cut portion 2131 to achieve sealing. Then, the sampling container 211 on the carrying plate is taken out by the gripper.

During implementation, a sensor may also be added to the processing device 300, so that after the sampling container 211 is taken out by the processing device 300, a weight of the sampling container 211 is fed back through the sensor, thereby having the effect of re-checking the weight of the liquid. It is also possible to roughly calculate the weight of the liquid by feeding back a force change after the processing device 300 has fetched out the sampling container 211.

In conclusion, in the sampling system provided in the embodiments of the present application, during implementation, a designated area can be set in advance in the clean workshop, at the window or at the entrance and exit, so as to fetch and place the sampling container 211. During operation, part of the liquid in the liquid container 10 is controlled by the tube assembly 100 to automatically enter the sampling container 211, so as to complete sampling.

Subsequently, the sampling container 211 is clamped by the gripper of the processing device 300, the sampling container 211 containing the liquid is separated from the tube assembly 100 by a cutting device, and finally the sampling container 211 is transferred to the designated area by the moving robot. Then, the operator only needs to remove the sampling container 211 from the designated area, so that the operator does not need to enter the clean workshop for manual sampling, so as to reduce the possibility of contamination to the clean workshop and the liquid, and improve the sampling efficiency at the same time, thereby solving the problem in the prior art that contamination is easily caused to the clean workshop or the liquid during sampling.

The embodiments of the present application further provide a sampling method, which is applied to the above-described sampling system, and includes the following steps:
transferring part of the liquid in the liquid container 10 to the sampling container 211 in the sampling system through the tube assembly 100 in the sampling system;
separating the sampling container 211 containing the liquid from the tube assembly 100 through the processing device 300 in the sampling system; and
transferring the sampling container 211 containing the liquid to a designated area through the processing device 300.

The specific structure of the sampling system has been described in detail in the above-mentioned embodiments, and will not be repeated herein.

It should be noted that during implementation, a designated area can be set in advance in the clean workshop, at the window, or at the entrance and exit, so that the sampling container 211 can be sent to the designated area subsequently by the processing device 300.

Specifically, the main tube 110 is controlled to open by the automatic valve 120 in the tube assembly 100, and then the sampling valve 214 corresponding to the sampling container 211 that needs to receive the liquid is opened by the gripper of the moving robot, so that part of the liquid in the liquid container 10 automatically enter the sampling container 211, completing the sampling. The branch tube 213 is then cut at the to-be-cut portion 2131 through the cutting device of the processing device 300 to separate the sampling container 211 containing the liquid from the tube assembly 100. Next, the sampling container 211 containing the liquid is clamped by the gripper of the processing device 300 and is transferred to the designated area.

Subsequently, the operator only needs to remove the sampling container 211 from the designated area, so that the operator does not need to enter the clean workshop for manual sampling, so as to reduce the possibility of contamination to the clean workshop and the liquid, and improve the sampling efficiency at the same time, thereby solving the problem in the prior art that contamination is easily caused to the clean workshop or the liquid during sampling.

Finally, it should be noted that those skilled in the art will easily come up with other embodiments of the present application after considering the specification and practicing the application disclosed herein. The present application is intended to cover any variations, uses, or adaptive changes of the present application, and these variations, uses, or adaptive changes follow the general principles of the present application and include common knowledge or conventional technical means in the art which are not disclosed in the present application; and the present application is not limited to the precise structures described above and shown in the accompanying drawings, and various modifications and changes can be made without departing from the scope thereof. The scope of the application is limited only by the appended claims.

What is claimed is:

1. A sampling system, comprising:
a tube assembly;
a liquid container and at least one sampling container,
wherein the at least one sampling container is in communication with the liquid container through the tube assembly, and the tube assembly controls liquid in the liquid container to enter or stop entering the at least one sampling container; and
a processing device, configured to separate the at least one sampling container from the tube assembly and transfer the at least one sampling container.

2. The sampling system according to claim 1, wherein the at least one sampling container comprises a plurality of sampling containers, the plurality of sampling containers form at least one group of sampling assemblies, and respective sampling containers in a same group of sampling assemblies are connected to each other.

3. The sampling system according to claim 2, wherein the sampling system further comprises at least one common joint and at least one branch tube, the plurality of sampling containers in the same group are correspondingly in communication with the at least one common joint through the at least one branch tube, and the at least one common joint is in communication with the tube assembly.

4. The sampling system according to claim 3, wherein at least one sampling valve is provided on the at least one common joint, each of the at least one sampling valve is correspondingly provided on each of the at least one branch tube, and the processing device is further configured to control actions of the at least one sampling valve, so as to control opening and closing of the at least one branch tube.

5. The sampling system according to claim 3, wherein at least part of the at least one branch tube is a to-be-cut portion, and
the to-be-cut portion is configured to be bent by the processing device after being cut by the processing device, so as to complete sealing.

6. The sampling system according to claim 1, wherein the sampling system further comprises a cabinet body, and each of the at least one sampling container is provided on the cabinet body.

7. The sampling system according to claim 6, wherein the sampling system further comprises at least one fixing clamp, and the at least one fixing clamp is configured to fix the at least one sampling container on the cabinet body.

8. The sampling system according to claim 1, wherein the tube assembly comprises a main tube, an automatic valve provided on the main tube, and a detecting sensor, wherein
the at least one sampling container is in communication with the liquid container through the main tube;
the automatic valve is configured to control opening and closing of the main tube; and
the detecting sensor is configured to detect a flow rate of a liquid flow through the main tube.

9. The sampling system according to claim 2, wherein the tube assembly comprises a main tube, an automatic valve provided on the main tube, and a detecting sensor, wherein
the plurality of sampling containers are in communication with the liquid container through the main tube;
the automatic valve is configured to control opening and closing of the main tube; and
the detecting sensor is configured to detect a flow rate of a liquid flow through the main tube.

10. The sampling system according to claim 3, wherein the tube assembly comprises a main tube, an automatic valve provided on the main tube, and a detecting sensor, wherein
the plurality of sampling containers are in communication with the liquid container through the main tube;
the automatic valve is configured to control opening and closing of the main tube; and
the detecting sensor is configured to detect a flow rate of a liquid flow through the main tube.

11. The sampling system according to claim 4, wherein the tube assembly comprises a main tube, an automatic valve provided on the main tube, and a detecting sensor, wherein
the plurality of sampling containers are in communication with the liquid container through the main tube;
the automatic valve is configured to control opening and closing of the main tube; and
the detecting sensor is configured to detect a flow rate of a liquid flow through the main tube.

12. The sampling system according to claim 5, wherein the tube assembly comprises a main tube, an automatic valve provided on the main tube, and a detecting sensor, wherein
the plurality of sampling containers are in communication with the liquid container through the main tube;
the automatic valve is configured to control opening and closing of the main tube; and
the detecting sensor is configured to detect a flow rate of a liquid flow through the main tube.

13. The sampling system according to claim 6, wherein the tube assembly comprises a main tube, an automatic valve provided on the main tube, and a detecting sensor, wherein
the at least one sampling container is in communication with the liquid container through the main tube;
the automatic valve is configured to control opening and closing of the main tube; and
the detecting sensor is configured to detect a flow rate of a liquid flow through the main tube.

14. The sampling system according to claim 7, wherein the tube assembly comprises a main tube, an automatic valve provided on the main tube, and a detecting sensor, wherein
the at least one sampling container is in communication with the liquid container through the main tube;
the automatic valve is configured to control opening and closing of the main tube; and
the detecting sensor is configured to detect a flow rate of a liquid flow through the main tube.

15. The sampling system according to claim 1, wherein the processing device comprises a moving robot, and the moving robot has a gripper and a cutting device, and wherein the gripper is configured to clamp the at least one sampling container and the cutting device is configured to detach the at least one sampling container from the tube assembly.

16. The sampling system according to claim 2, wherein the processing device comprises a moving robot, and the moving robot has a gripper and a cutting device, and wherein the gripper is configured to clamp the plurality of sampling containers and the cutting device is configured to detach the plurality of sampling containers from the tube assembly.

17. The sampling system according to claim 3, wherein the processing device comprises a moving robot, and the moving robot has a gripper and a cutting device, and wherein the gripper is configured to clamp the plurality of sampling containers and the cutting device is configured to detach the plurality of sampling containers from the tube assembly.

18. The sampling system according to claim 4, wherein the processing device comprises a moving robot, and the moving robot has a gripper and a cutting device, and wherein the gripper is configured to clamp the plurality of sampling containers and the cutting device is configured to detach the plurality of sampling containers from the tube assembly.

19. The sampling system according to claim 5, wherein the processing device comprises a moving robot, and the moving robot has a gripper and a cutting device, and wherein the gripper is configured to clamp the plurality of sampling containers and the cutting device is configured to detach the plurality of sampling containers from the tube assembly.

20. A sampling method applied to the sampling system according to claim 1, comprising the following steps:
transferring part of the liquid in the liquid container to the at least one sampling container in the sampling system through the tube assembly in the sampling system;
separating the at least one sampling container containing the liquid from the tube assembly through the processing device in the sampling system; and
transferring the at least one sampling container containing the liquid to a designated area through the processing device.
